(19) United States
(12) Patent Application Publication
(10) Pub. No.: US 2026/0041271 A1
(43) Pub. Date: Feb. 12, 2026

(54) DUAL-PURPOSE COFFEE FILTER HANGING STRUCTURE

(71) Applicants: MING-YANG CHEN, New Taipei City (TW); CHAN-LIANG WANG, New Taipei City (TW); MING-SHENG CHEN, New Taipei City (TW)

(72) Inventors: MING-YANG CHEN, New Taipei City (TW); CHAN-LIANG WANG, New Taipei City (TW); MING-SHENG CHEN, New Taipei City (TW)

(21) Appl. No.: 18/849,882

(22) PCT Filed: Mar. 28, 2022
(86) PCT No.: PCT/CN2022/083414

§ 371 Date: Sep. 23, 2024

(51) Int. Cl. A47J 31/08

(52) U.S. Cl. CPC A47J 31/08

(57) ABSTRACT

A dual-purpose coffee filter hanging structure, comprising a filter bag and a hanging ear device separately provided on both sides of the filter bag. A fixing portion is provided in the hanging ear device; the fixing portion extends upwards to form a connecting section, the end of the connecting section extending upwards is provided with an inner ring section; an inner engaging groove is formed on the inner ring section adjacent to the connecting section; an outer ring section is provide on the outer side of the inner ring section; a first outer engaging groove is formed on each of two sides of the outer ring section; two inner engaging grooves and two first outer engaging grooves are provided opposite to each other in pairs in the vertical direction; both the inner engaging grooves and the first outer engaging grooves can be used to hang on the rim of a cup; and therefore, according to different requirements, the filter bag can be hung upright or obliquely on the cup to extract coffee.

### TECHNICAL FIELD

The present invention relates to a dual-purpose coffee filter hanging structure, hanging on a container for extracting coffee, especially can be fixed on the container in an upright or oblique hanging manner according to different needs, which is a filter structure allows the user to choose the coffee extraction mode.

### DESCRIPTION OF THE RELATED ART

Filtering coffee or hanging ear coffee mainly use filter paper to hold ground coffee powder and hang it on the mouth of the cup for users to add hot water for brewing to extract the charming flavor and aroma of the coffee, so as to achieve the purpose of tasting coffee.

In the prior art, the filtering coffee or hanging ear coffee is made according to the extraction method. The filter paper is made into a slightly square filter bag or a funnel-shaped filter bag. Depending on the time and extraction method, the two types of filter bags will present very different flavors, which are described below for the square filter bag and the funnel-shaped filter bag.

The top of the slightly square filter bag has a water inlet, the lug is hung on the mouth of the cup, so that the water inlet at the top of the filter bag can be opened for hot water to be added to the brewing of coffee powder. Because the bottom of the filter bag is long, so it can prolong the time of contact between the coffee powder and the hot water. The user can control the time of contact between the hot water and the coffee powder, in order to extract the flavor and aroma of coffee full of different strengths.

The top of the funnel-shaped filter bag is larger than the bottom, so the brewed coffee liquid will fall directly into the cup, which greatly shortens the contact time between the hot water and the coffee powder and achieves the purpose of quickly extracting the coffee within a short period of time, to make the coffee taste fresher and more refreshing.

### BRIEF SUMMARY OF THE INVENTION

### Technical Problems

However, all existing commercially available filter-hung coffee products have already been developed in the form of filter bags. No matter which type of filter bag the user purchases, they can only brew and extract coffee according to the purchased filter bag form, and cannot change the brewing mode of the filter bag.

In the prior art, the lugs of the filtering type or the hanging ear type are made of paper, and they are only simple grooves to provide hanging. Due to the elasticity of the paper material, the grooves are rather detached from the mouths of the cups, and the hanging effect is not good.

### Solution to the Problems/technical Solutions

In the present invention, a plurality of structures that can be pulled, folded or unfolded are designed on the hanging ear structure are used to hang the filter bag in the mouth of the container in an upright or diagonal manner. When hanging upright, the water inlet at the top of the filter bag is open, and the filter bag is hung on the mouth of the container to perform coffee filter hanging extraction. If it is desired to brew in funnel filter bag mode, open at least one of the adjacent sides of the water inlet at the top to form a funnel-shaped filter paper, and then hang the filter paper diagonally over the mouth of the container to carry out coffee filter extraction. Therefore, the present invention allows users to use different hanging methods by changing the hanging ear structure. User can optionally use a square filter bag for coffee brewing, or change the filter bag from a square filter bag to a funnel-shaped filter bag for coffee extraction.

The present invention further designs a buckle structure for the hooking structure to improve the stability of the hooking.

The dual-purpose coffee filter hanging structure of the present invention at least includes a filter bag and a hanging ear device provided on two lateral surfaces of the filter bag. The filter bag has a chamber, a water inlet is provided on the filter bag, and a side adjacent to the water inlet is provided with a tearable edge, and each tearable edge is in a closed state under a normal condition and is torn apart during use. The hanging ear device has a fixing portion inside. Each fixing portion of the two hanging ear devices is fixed on two lateral surfaces of the filter bag, the fixing portion extends upwards with a connecting section, an inner ring section extends above the connecting section, the inner ring section covers a periphery of the fixing portion and the connecting section, the inner ring section forms an inner engaging groove adjacent to the connecting section, an outer ring section is provided on an outer side of the inner ring section, a first outer engaging groove is formed on both sides of the outer ring section, except for an area around the first outer engaging groove, remaining area of the outer ring section is fixedly arranged on a lateral side of the filter bag, the two inner engaging grooves are close to the water inlet, and the two first outer engaging grooves are away from the water inlet, so that the two inner engaging grooves and the two first outer engaging grooves are provided opposite to each other in pairs in the vertical direction. The inner ring section is pulled out, so that the inner ring section is separated from the outer ring section and connected with the connecting section. The connecting section can pull out the fixing portion and both lateral surfaces of the filter bag together, so that the space within the chamber can be opened, and the inner engaging groove and the first outer engaging groove can be used to hang on the rim of a cup. Therefore, different hanging methods can be used according to different needs for extraction.

A preferred solution is that the connecting section is convexly provided with a first convex end on two sides facing outward respectively, the inner ring section is convexly provided with a second convex end inwardly relative to each first convex end respectively, and the inner engaging groove is adjacent to the first convex end and the second convex end.

A preferred solution is that the first outer engaging groove is formed by two sides of the outer ring section facing outwards, a third convex end is adjacent to the first outer engaging groove, and the third convex end and an area around the first outer engaging groove are not fixedly arranged on two lateral surfaces of the filter bag.

A preferred solution is that the first outer engaging groove is formed by two sides of the outer ring section facing inward, a third convex end is provided inside the first outer engaging groove, and the third convex end and an area around the first outer engaging groove are not fixedly arranged on the two lateral surfaces of the filter bag.

A preferred solution is that a flip piece facing outward is formed respectively on both sides of the inner ring section near each inner engaging groove, a second outer engaging groove is formed on an inner edge of the flip piece, and the two second outer engaging grooves are close to the water inlet, so that the two second outer engaging grooves and the two first outer engaging grooves are provided opposite to each other in pairs in the vertical direction, so that an user can selectively use either the inner engaging groove or the second outer engaging groove.

A preferred solution is that the inner ring section extends outwards with a plurality of convex portions, and each convex portion is provided so that a corresponding concave portion is formed inside the outer ring section.

A preferred solution is that a second outer engaging groove facing outward is formed respectively on two sides of the outer ring section near each inner engaging groove, a fourth convex end is adjacent to the second outer engaging groove, the fourth convex end and an area around the second outer engaging groove are not fixedly arranged on two lateral surfaces of the filter bag, and the two second outer engaging grooves are close to the water inlet, so that the two second outer engaging grooves and the two first outer latching grooves are provided opposite to each other in pairs in the vertical direction, so that an user can selectively use either the inner engaging groove or the second outer engaging groove.

A preferred solution is that an outer pulling portion extends outside the inner ring section, and the outer pulling portion causes the outer ring section to be formed with a disconnecting portion, and the disconnecting portion is located between the two first outer engaging grooves.

A preferred solution is that the hanging ear device comprises a plurality of cut lines cut into a sheet, such that a plurality of the fixing portion, the connecting section, the inner ring section, each inner engaging groove, the outer ring section and each first outer engaging groove, which are pullable, foldable, or spreadable, are formed on the sheet with each cut line.

A preferred solution is that a tearable sealing edge is provided on the water inlet.

### BRIEF DESCRIPTION OF THE DRAWINGS/DESCRIPTION OF THE DRAWINGS

The present invention will be further described in detail below in association with the accompanying drawings and specific embodiments.

FIG. 1 is a schematic plan view of the overall structure of the dual-purpose coffee filter hanging structure of the present invention.

FIG. 2 is a schematic structural plan view of the hanging ear device in the first embodiment of the dual-purpose coffee filter hanging structure of the present invention.

FIG. 3 is a schematic three-dimensional view of the upright hanging in the first embodiment of the dual-purpose coffee filter hanging structure of the present invention.

FIG. 4 is a schematic plan view of the filter bag for upright hanging of the dual-purpose coffee filter hanging structure of the present invention.

FIG. 5 is a schematic plan view of the filter bag for oblique hanging of the dual-purpose coffee filter hanging structure of the present invention.

FIG. 6 is a schematic plan view of the upright hanging in the first embodiment of the dual-purpose coffee filter hanging structure of the present invention.

FIG. 7 is a schematic plan view of the oblique hanging in the first embodiment of the dual-purpose coffee filter hanging structure of the present invention.

FIG. 8 is a schematic structural plan view of the hanging ear device in the second embodiment of the dual-purpose coffee filter hanging structure of the present invention.

FIG. 9 is a schematic plan view of the oblique hanging in the second embodiment of the dual-purpose coffee filter hanging structure of the present invention.

FIG. 10 is a schematic structural plan view of the hanging ear device in the third embodiment of the dual-purpose coffee filter hanging structure of the present invention.

FIG. 11 is a schematic plan view of the oblique hanging in the third embodiment of the dual-purpose coffee filter hanging structure of the present invention.

FIG. 12 is another schematic plan view of the oblique hanging in the third embodiment of the dual-purpose coffee filter hanging structure of the present invention.

FIG. 13 is a schematic structural plan view of the hanging ear device in the fourth embodiment of the dual-purpose coffee filter hanging structure of the present invention.

FIG. 14 is a schematic plan view of the oblique hanging in the fourth embodiment of the dual-purpose coffee filter hanging structure of the present invention.

### REFERENCE EXPLANATIONS OF THE DRAWINGS

1. Filter bag
11. Chamber
12. Water inlet
121. Sealing edge
13. Tearable edge
2. Hanging ear device
20. Sheet
201. Cut line
21. Fixing portion
22. Connecting section
221. First convex end
23. Inner ring section
231. Second convex end
232. Outer pulling portion
233. Convex portion
24. Internal engaging groove
25. Outer ring section
251. Disconnecting portion
252. concave portion
26. First outer engaging groove
261. Third convex end
27. Flip piece
28. Second outer engaging groove
281. Fourth convex end
3. Cup
31. Cup rim

### BEST EMBODIMENT FOR IMPLEMENTING THE INVENTION/BEST MODE FOR IMPLEMENTING THE INVENTION

The technical solutions in the embodiments of the present invention are described clearly and completely below in association with the accompanying drawings in the embodiments of the present invention. Many specific details are set forth in the following description in order to facilitate a full understanding of the present invention, but the present invention can also be implemented in other ways different from those described herein. Persons skilled in the art can make similar promotions without violating the connotations of the present invention, and thus the present invention is not limited by the specific embodiments disclosed hereinafter.

Other technical contents, features and effects of the present invention will be clearly presented in the following detailed description of the preferred embodiments with reference to the drawings.

The terms “top”, “bottom”, “front”, “back”, “left”, “right”, and “side”, which are used to describe the names of the components, are disclosed in the contents of the specification of the present invention. The terms “top”, “bottom”, “front”, “back”, “left”, “right”, and “side” used to describe the names of the components are disclosed in the contents of the document to assist in the identification of the positional relationship between the plate structures, and the orientation of the actual product structure will vary with the angle of placement or the user. The direction of the actual product structure may change according to the angle of placement or the user's location, and cannot therefore limit the scope of equal coverage of the present invention.

As used herein, the terms “inside” and “interior” to describe the location of a structure refer to the central position close to the structure body, or a position that is not exposed in use; the term “inward” refers to the direction close to the structure body. The central position, or a position that is not exposed in use; the terms “outside” and “exterior” refer to the central position away from the structure body, or a position that is exposed in use; the terms “outward” refer to a position that is away from the structure body central location, or towards an exposed location in use.

As used herein, the term “away” to describe the location of a structure refers to a location that is further away between two target structures; the term “close” or “adjacent” refers to a position closer to the two target structures.

The terms “protruding”, “forming” or “extending” disclosed in the description of the present invention to describe the relationship between structural combinations generally refer to one structure being integrally combined with another structure.

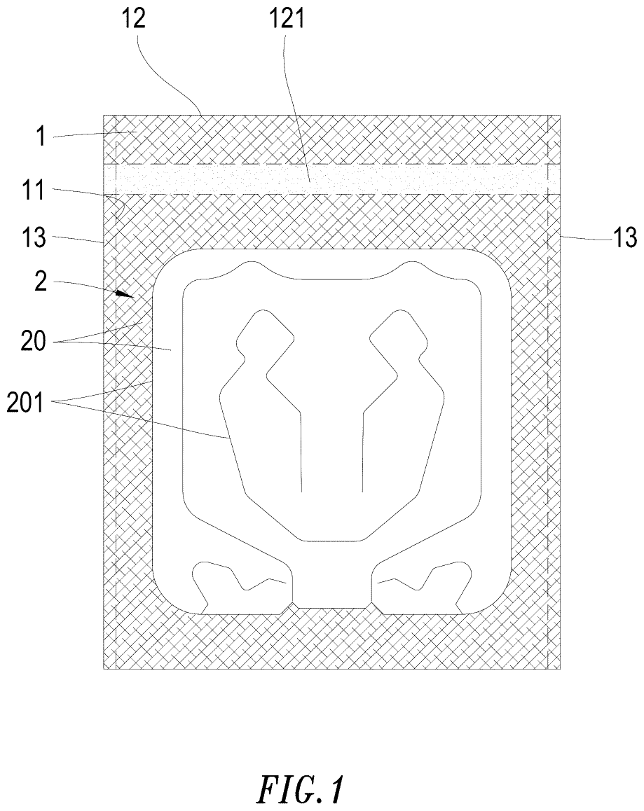

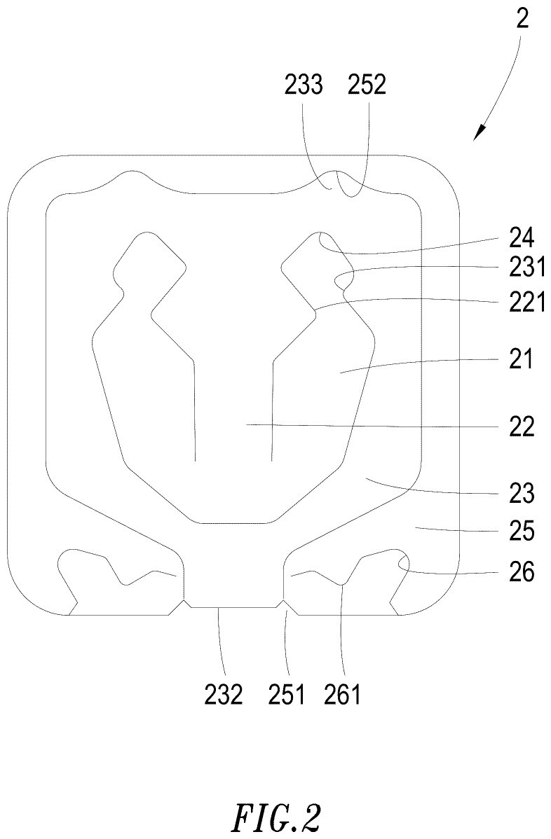

The dual-purpose coffee filter hanging structure of the present invention, as shown in FIGS. 1 to 2, is a schematic plan view of the overall structure. As shown in the figure, it includes at least one filter bag 1 and a hanging ear device 2 located on both lateral surfaces of the filter bag (both sides are symmetrical, only one side is shown in the picture). The filter bag 1 is used to fill the coffee brewing material. The hanging ear device 2 is used for attaching to the cup. When water is added to the filter bag 1, the coffee can be brewed into the cup.

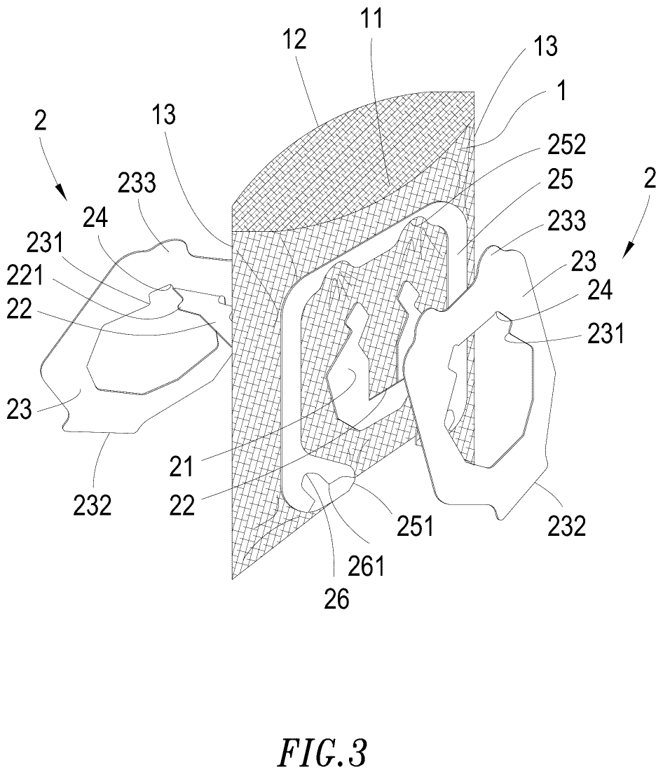

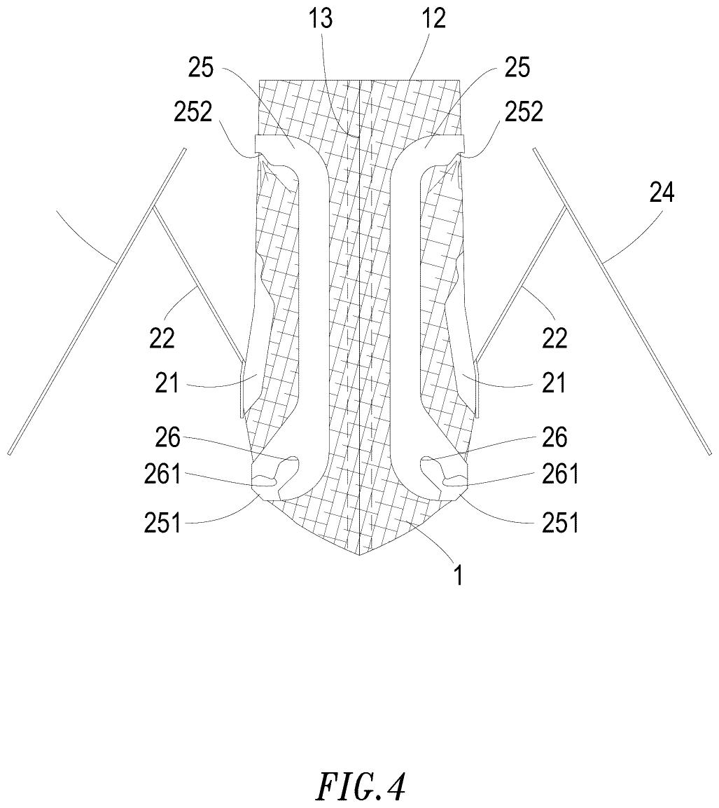

Referring to FIGS. 1 to 5, the filter bag 1 has a chamber 11. One side of the filter bag 1 is provided with a water inlet 12, and a tearable sealing edge 121 is provided on the water inlet 12. After the sealing edge 121 is torn, the water inlet 12 can be opened for upright hanging. One or two adjacent sides of the water inlet 12 are set as a tearable edge 13. The tearable edge 13 is preferably sealed with high frequency. Each tearable edge 13 is in a closed state under normal conditions, and can be torn apart during use. The torn tearable edge 13 is connected to the water inlet 12 to form a larger opening for oblique hanging. The upright hanging and oblique hanging are used with the hanging ear device 2, which will be described later in detail associated with the hanging ear device 2.

Please refer to FIG. 1. The hanging ear device 2 has a plurality of cut lines 201 cut into a sheet 20, such that a plurality of pullable, foldable, or spreadable blocks are formed on the sheet 20 with each cut line 201. Each block can have different shapes and hanging effects depending on the design of each cut line 201. Therefore, different designs are presented by four different embodiments in the specification, which are described in detail below.

Please refer to FIGS. 2 to 5 for illustrating the first embodiment of the hanging ear device. The blocks have a fixing portion 21 inside the hanging ear device 2 respectively, and the fixing portion 21 extends upwards with a connecting section 22. The connecting section 22 is provided convexly with a first convex end 221 respectively on two sides facing outward. The connecting section 22 extends upwards with an inner ring section 23. The inner ring section 23 covers the periphery of the fixing portion 21 and the connecting section 22. The inner ring section 23 is convexly provided with a second convex end 231 inwardly relative to each first convex end 221 respectively. The inner ring section 23 adjacent to the connecting section 22 forms an incompletely closed inner engaging groove 24. The inner engaging groove 24 is adjacent to the first convex end 221 and the second convex end 231. Regarding the outline design, the first convex end 221 and the second convex end 231 are both designed to be tapered. The tapered sides of the first convex end 221 and the second convex end 231 are located on both sides below each inner engaging groove 24, and the top of each inner engaging groove 24 is designed as a diamond shape in correspondence with its tapered edge.

An outer ring section 25 is provided on the outside of the inner ring section 23. An outwardly facing first outer engaging groove 26 is formed on both sides of the outer ring section 25 respectively. A third convex end 261 is adjacent to the first outer engaging groove 26. The remaining area of the outer ring section 25 and the fixing portion 21, except for the area around the first outer engaging groove 26 and the third convex end 261, are fixedly disposed (adhered) to the two lateral surfaces of the filter bag 1. Regarding the outline design, the first outer engaging groove 26 is designed as a tilted U-shape, with its tilted direction facing outward at the top and inward at the bottom. The third convex end 261 is designed to be tapered, and the inner ring section 23 extends away from the outer side of the inner engaging groove 24 with an outer pulling portion 232. The outer pulling portion 232 causes the outer ring section 25 to be formed with a disconnecting portion 251. The disconnecting portion 251 is located between the two first outer engaging grooves 26.

In the specific position configuration, the two inner engaging grooves 24 are close to the water inlet 12, and the two first outer engaging grooves 26 are away from the water inlet 12, so that the two inner engaging grooves 24 and the two first outer engaging grooves 26 are provided opposite to each other in pairs in the vertical direction.

The inner ring section 23 extends outwards with a plurality of convex portions 233. Each convex portion 233 is arranged so that a corresponding concave portion 252 is formed inside the outer ring section 25.

Please refer to FIGS. 2 to 5. When the first embodiment is used, the sealing edge 121 is torn open, and the outer pulling portions 232 of the two hanging ear devices 2 are pulled out. Accordingly, the inner ring section 23 is separated from the outer ring section 25 and the fixing portion 21. The inner ring section 23 is also connected to the connecting section 22. The connecting section 22 can pull out the fixing portion 21 and both lateral surfaces of the filter bag 1 together, so that the space within the chamber 11 can be opened, and the filter bag 1 can be hung on the cup rim 31 of a cup 3 through the hanging ear device 2. Different hanging methods can be used according to different needs.

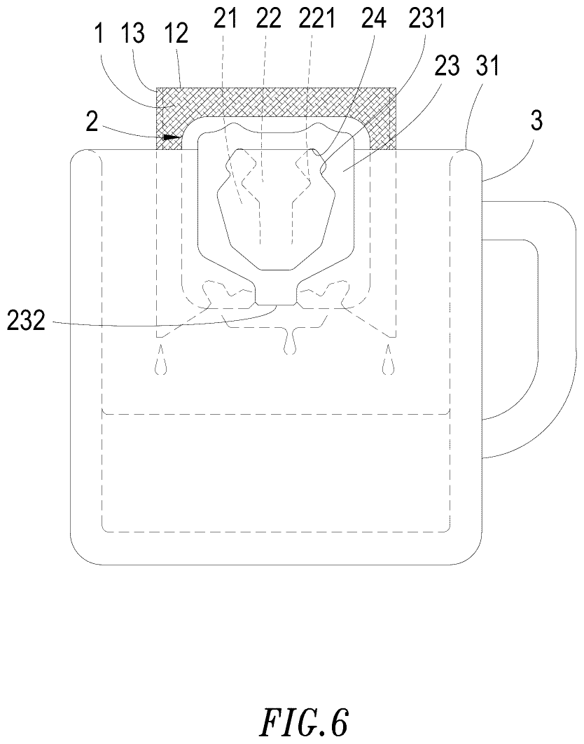

(1) Please refer to FIGS. 2 to 6, the hanging ear device 2 is hung upright, so that the cup rim 31 is buckled in the position of each inner engaging groove 24. The first convex end 221 and the second convex end 231 can be effectively clamped on the cup rim 31. The filter bag 1 faces upward corresponding to the water inlet 12 above the fixing portion 21, in order to pour the extraction raw material (coffee powder) into the chamber 11 through the water inlet 12 for extraction. The hanging method allows coffee to be filtered out through the edge of the bottom of the filter bag 1.

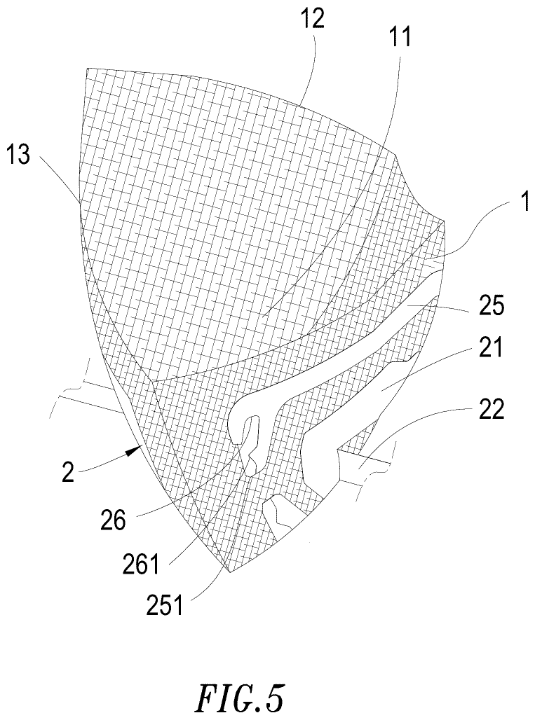

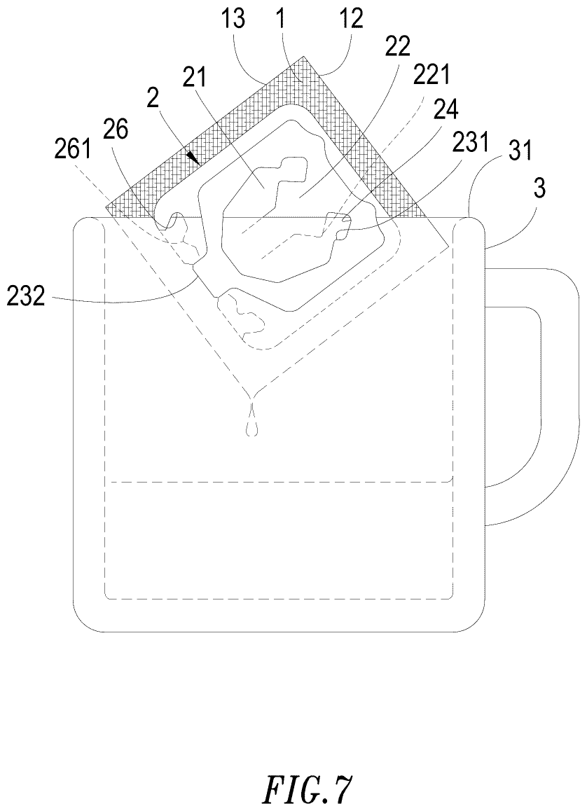

(2) Please refer to FIG. 2, FIG. 5, and FIG. 7, the hanging ear device 2 is hung diagonally, and one of the tearable edges 13 is torn apart. Since the first outer engaging groove 26 and the third convex end 261 are not adhered to the filter bag 1, when the inner ring section 23 is pulled for pulling out two lateral surfaces of the filter bag 1, the unadhered first outer engaging groove 26 and the third convex end 261 can be naturally exposed, to facilitate the cup rim 31 to be snapped into one of the inner engaging grooves 24 and the first outer engaging grooves 26 located diagonally from the inner engaging grooves 24. The first convex end 221, the second convex end 231 and the third convex end 261 can be effectively clamped on the cup rim 31. The water inlet 12 and the torn tearable edge 13 are respectively facing obliquely upward, so as to connectively forms a larger opening. Therefore, the extraction raw material (coffee powder) is poured into the chamber 11 through the opening in connection with the water inlet 12 and the tearable edge 13 for extraction. The hanging method allows the coffee to be filtered through the tip where the two edges at the bottom of the filter bag 1 intersect.

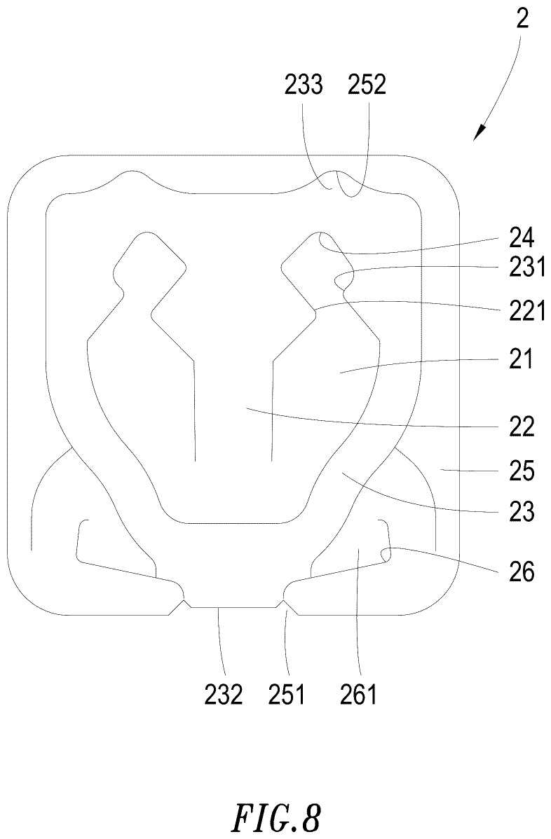

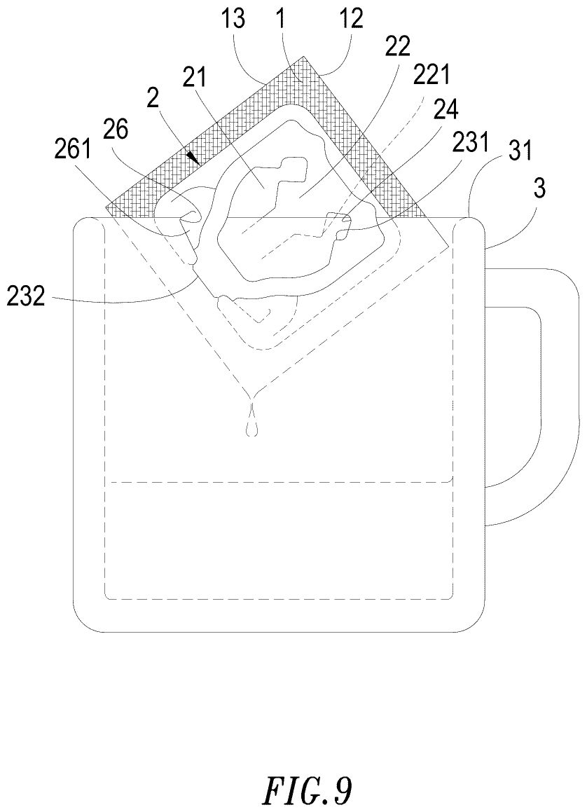

Please refer to FIGS. 8 to 9 for illustrating the second embodiment of the hanging ear device. The difference between the second embodiment and the first embodiment is that the first outer engaging groove 26 is formed by the two sides of the outer ring segment 25 facing inward respectively. The third convex end 261 is located inside the first outer engaging groove 26. Regarding outline design, the first outer engaging groove 26 and the third convex end 261 are designed to be tapered. The remaining structural features are the same as those of the first embodiment and will not be repeated again.

Please refer to FIGS. 8 to 9. When the second embodiment is used and implemented, the hanging ear device 2 is hung upright in the same manner as in the first embodiment and will not be repeated again. The hanging ear device 2 is hung diagonally and one of the tearable edges 13 is torn apart, in order to allow the cup rim 31 to snap into one of the inner engaging grooves 24 and pull apart the third convex end 261 within the first outer engaging groove 26 in the diagonal direction of the inner engaging groove 24. Accordingly, the third convex ends 261 is pulled apart to buckle the cup rim 31. The first convex end 221, the second convex end 231 and the third convex end 261 can be effectively clamped on the cup rim 31. The water inlet 12 and the torn tearable edge 13 face obliquely upward respectively, so as to provide larger openings in connection with each other. Therefore, the extraction material (ground coffee) is poured into the chamber 11 through the opening of the water inlet 12 in connection with the tearable edge 13 for extraction. The hanging method allows the coffee to be filtered through the tip where the two edges at the bottom of the filter bag 1 intersect.

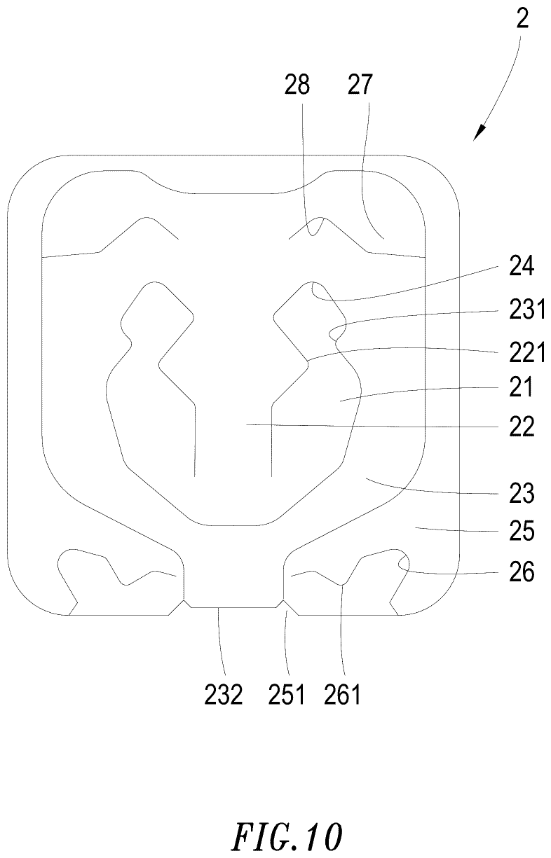

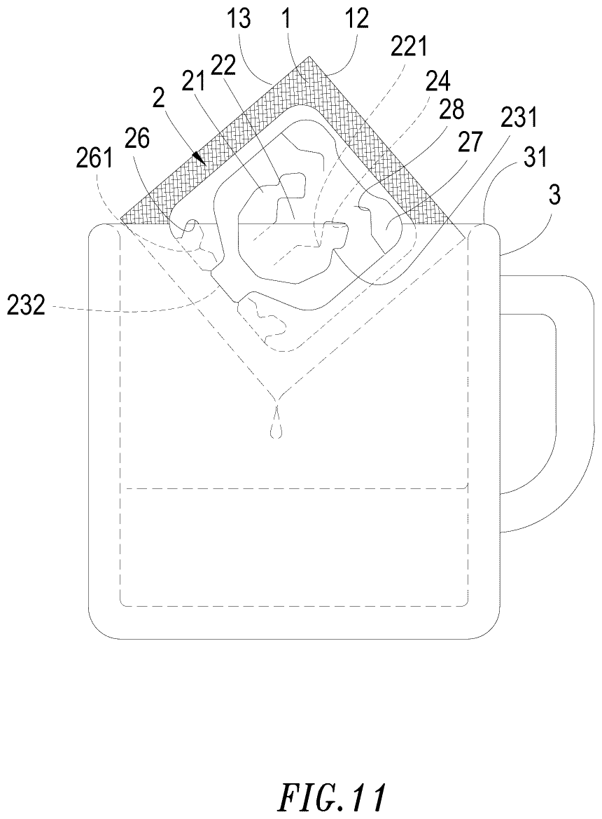

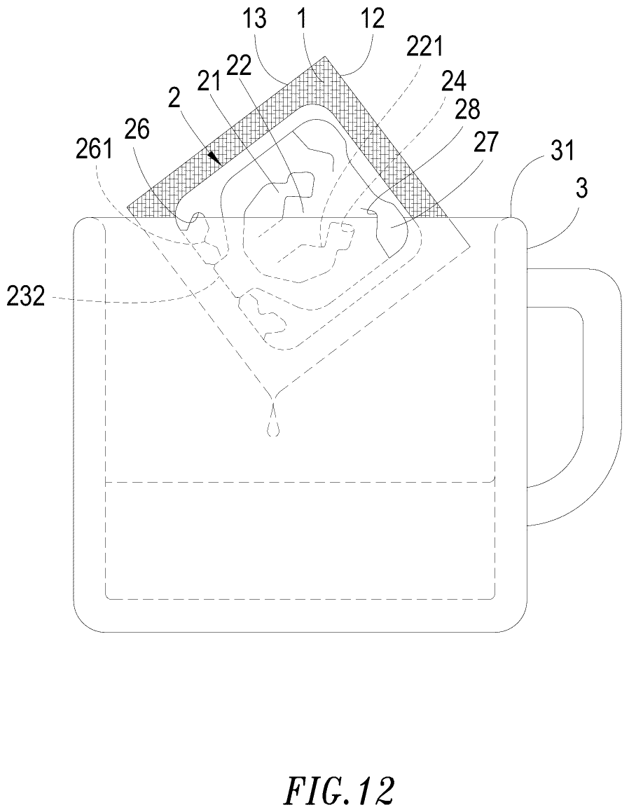

Please refer to FIGS. 10 to 12 for illustrating the third embodiment of the hanging ear device. The difference between the third embodiment and the first embodiment is that an outwardly facing flip piece 27 is formed on two sides of the inner ring section 23 near each inner engaging groove 24. A second outer engaging groove 28 is formed on the inner edge of the flip piece 27. Regarding the outline design, the second outer engaging groove 28 is designed to be tapered.

In the specific position configuration, the two inner engaging grooves 24 and the two second outer engaging grooves 28 are close to the water inlet 12, and the two first outer engaging grooves 26 are away from the water inlet 12, so that the two inner engaging grooves 24 and the two first outer engaging grooves 26 are provided opposite to each other in pairs in the vertical direction. Alternatively, the two second outer engaging grooves 28 and the two first outer engaging grooves 26 are provided opposite to each other in pairs in the vertical direction. The coupling grooves 26 are provided opposite to each other in pairs in the vertical direction. Therefore, the inner engaging groove 24 or the second outer engaging groove 28 can be selectively used. The remaining structural features are the same as those of the first embodiment and will not be repeated again.

The inner engaging groove 24 or the second outer engaging groove 28 included in the third embodiment can be used in association with the first outer engaging groove 26. The two second outer engaging grooves 28 are also located on the outer side compared to the two inner engaging grooves 24. Therefore, when in use, the second outer engaging groove 28 on the outer side is suitable for fitting larger cups 3, and the inner engaging groove 24 on the inner side is suitable for fitting smaller cups 3.

Please refer to FIGS. 10 to 12. When the third embodiment is used, the hanging ear device 2 is hung upright as the same manner with the first embodiment, and thus will not be repeated again. If the diameter of the cup 3 is larger, one of the tearable edges 13 is torn apart, and the flip piece 27 is pulled out, so that the cup rim 31 is locked in one of the inner engaging grooves 24 and the second outer engaging groove 28 in the diagonal direction of the inner engaging groove 24. The flip piece 27 and the third convex end 261 can be effectively clamped on the cup rim 31, and the water inlet 12 and the torn tearable edge 13 are respectively facing obliquely upward, so as to provide larger openings in connection with each other.

If the diameter of the cup 3 is small, one of the tearable edges 13 is torn, so that the cup rim 31 is locked in one of the inner engaging grooves 24 and the first outer engaging groove 26 in the diagonal direction of the inner engaging groove 24. The first convex end 221, the second convex end 231 and the third convex end 261 can be effectively clamped on the cup rim 31. The water inlet 12 and the torn tearable edge 13 are both facing obliquely upward, and are connected to provide larger openings. Therefore, the extraction material (ground coffee) is poured into the chamber 11 through the opening connected with the water inlet 12 and the tearable edge 13 for extraction. The hanging method allows the coffee to be filtered through the tip where the two edges at the bottom of the filter bag 1 intersect.

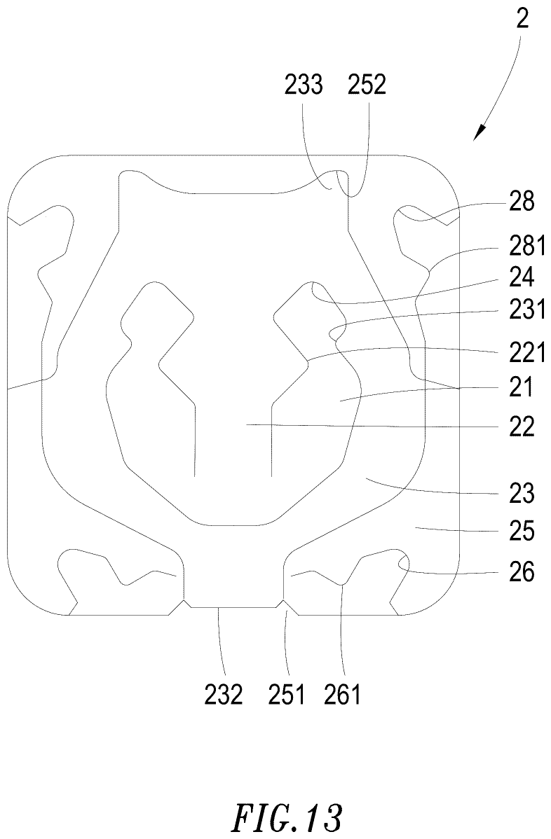

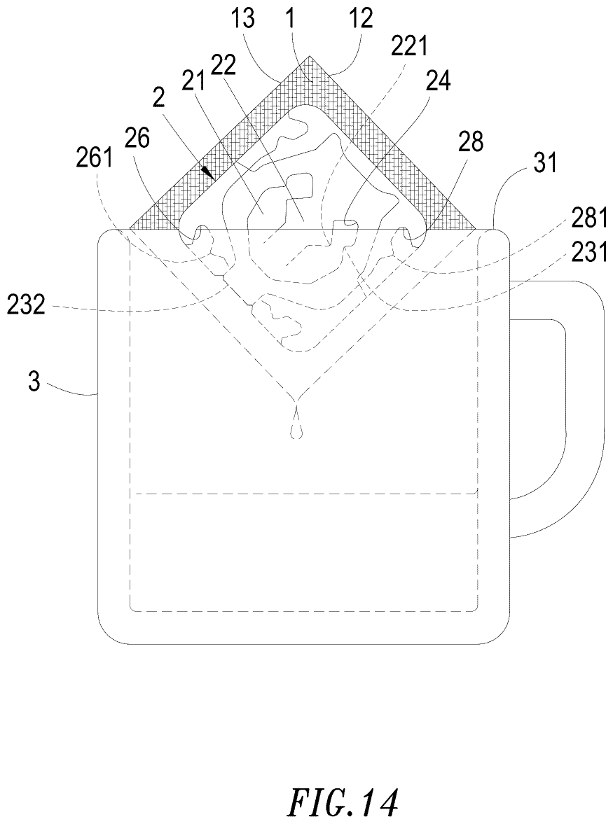

Please refer to FIGS. 13 to 14 for illustrating the fourth embodiment of the hanging ear device. The difference between the fourth embodiment and the first embodiment is that an outwardly facing second outer engaging groove 28 is formed on both sides of the outer ring section 25 close to the inner engaging grooves 24. A fourth convex end 281 is adjacent to the second outer engaging groove 28. The remaining area of the outer ring section 25 and the fixing portion 21, except for the area around the first outer engaging groove 26, the third convex end 261, the second outer engaging groove 28, the fourth convex end 281, are fixedly disposed (adhered) to the two lateral surfaces of the filter bag 1. Regarding the outline design, the second outer engaging groove 28 is designed as a tilted U-shape, with its tilted direction facing inward at the top and outward at the bottom. Moreover, the fourth convex end 281 is designed to be tapered.

In the specific position configuration, the two inner engaging grooves 24 and the two second outer engaging grooves 28 are close to the water inlet 12, and the two first outer engaging grooves 26 are away from the water inlet 12, so that the two inner engaging grooves 24 and the two first outer engaging grooves 26 are provided opposite to each other in pairs in the vertical direction. Alternatively, the two second outer engaging grooves 28 and the two first outer engaging grooves 26 are provided opposite to each other in pairs in the vertical direction. Therefore, the inner engaging groove 24 or the second outer engaging groove 28 can be selectively used. The other structural features are the same as those in the first embodiment and thus will not be repeated again.

The inner engaging groove 24 or the second outer engaging groove 28 included in the fourth embodiment can be used in association with the first outer engaging groove 26. The two second outer engaging grooves 28 are also located on the outer side compared to the two inner engaging grooves 24. Therefore, when in use, the second outer slot 28 on the outer side is suitable for fitting larger cups 3, and the inner engaging groove 24 on the inner side is suitable for fitting smaller cups 3.

Please refer to FIG. 13 to FIG. 14. When the fourth embodiment is used and implemented, the hanging ear device 2 is hung upright and is the same as the first embodiment, so will not be repeated again. If the diameter of the cup 3 is larger, one of the tearable edges 13 is torn apart, so that the cup rim 31 is locked in one of the inner engaging grooves 24 and the second outer engaging groove 28 in the diagonal direction of the inner engaging groove 24. The fourth convex end 281 can be effectively clamped on the cup rim 31. The water inlet 12 and the torn tearable edge 13 are respectively facing obliquely upward, so as to provide larger openings in connection with each other.

If the diameter of the cup 3 is small, one of the tearable edges 13 is torn apart, so that the cup rim 31 is locked in one of the inner engaging grooves 24 and the first outer engaging groove 26 in the diagonal direction of the inner engaging groove 24. The first convex end 221, the second convex end 231 and the third convex end 261 can be effectively clamped on the cup rim 31. The water inlet 12 and the torn tearable edge 13 are all facing obliquely upward, and are connected to provide larger openings. Therefore, the extraction material (ground coffee) is poured into the chamber 11 through the opening connected with the water inlet 12 and the tearable edge 13 for extraction. The hanging method allows the coffee to be filtered through the tip where the two edges at the bottom of the filter bag 1 intersect.

Please refer to FIGS. 1 to 14. The advantages of the present invention include:
(1) Since the coffee is filtered out from different paths, different flavors will be produced. Each hanging ear device 2 can provide different hanging methods to change the path through which the coffee is filtered out from the filter bag 1. Therefore, the user can freely choose the method of coffee filtering, and the use is more diversified;
(2) In the use of oblique hanging, the inner engaging groove 24 or the second outer engaging groove 28 can be selectively used to match the inner engaging groove 24. It can be conveniently matched to the cup 3 with different caliber sizes, and thus can also make the use more diversified.
(3) The inner engaging groove 24, the first outer engaging groove 26 and the second outer engaging groove 28 have the first convex end 221, the second convex end 231, the third convex end 261 and the fourth convex end 281 respectively, to assist in buckling on the cup rim 31. Therefore, the buckling effect can be improved.

Obviously, the described embodiments are merely some of the embodiments of the present invention and not all of them. Based on the embodiments in the present invention, all other embodiments obtained by persons of ordinary skill in the art without creative labor are within the scope of protection of the present invention.

What is claimed is:

1. A dual-purpose coffee filter hanging structure, characterized in that, at least comprising:
a filter bag, the filter bag has a chamber, a water inlet is provided on the filter bag, and a side adjacent to the water inlet is provided with a tearable edge, and each tearable edge is in a closed state under a normal condition and is torn apart during use; and
two hanging ear devices, having a fixing portion inside, wherein each fixing portion of the two hanging ear devices is fixed on two lateral surfaces of the filter bag, the fixing portion extends upwards with a connecting section, an inner ring section extends above the connecting section, the inner ring section covers a periphery of the fixing portion and the connecting section, the inner ring section forms an inner engaging groove adjacent to the connecting section, an outer ring section is provided on an outer side of the inner ring section, a first outer engaging groove is formed on both sides of the outer ring section, except for an area around the first outer engaging groove, remaining area of the outer ring section is fixedly arranged on a lateral side of the filter bag, the two inner engaging grooves are close to the water inlet, and the two first outer engaging grooves are away from the water inlet, so that the two inner engaging grooves and the two first outer engaging grooves are provided opposite to each other in pairs in the vertical direction.

2. The dual-purpose coffee filter hanging structure according to claim 1, characterized in that, the connecting section is convexly provided with a first convex end on two sides facing outward respectively, the inner ring section is convexly provided with a second convex end inwardly relative to each first convex end respectively, and the inner engaging groove is adjacent to the first convex end and the second convex end.

3. The dual-purpose coffee filter hanging structure according to claim 1, characterized in that, the first outer engaging groove is formed by two sides of the outer ring section facing outwards, a third convex end is adjacent to the first outer engaging groove, and the third convex end and an area around the first outer engaging groove are not fixedly arranged on two lateral surfaces of the filter bag.

4. The dual-purpose coffee filter hanging structure according to claim 1, characterized in that, the first outer engaging groove is formed by two sides of the outer ring section facing inward, a third convex end is provided inside the first outer engaging groove, and the third convex end and an area around the first outer engaging groove are not fixedly arranged on the two lateral surfaces of the filter bag.

5. The dual-purpose coffee filter hanger structure according to claim 1, characterized in that, a flip piece facing outward is formed respectively on both sides of the inner ring section near each inner engaging groove, a second outer engaging groove is formed on an inner edge of the flip piece, and the two second outer engaging grooves are close to the water inlet, so that the two second outer engaging grooves and the two first outer engaging grooves are provided opposite to each other in pairs in the vertical direction, so that an user can selectively use either the inner engaging groove or the second outer engaging groove.

6. The dual-purpose coffee filter hanging structure according to claim 1, characterized in that, a second outer engaging groove facing outward is formed respectively on two sides of the outer ring section near each inner engaging groove, a fourth convex end is adjacent to the second outer engaging groove, the fourth convex end and an area around the second outer engaging groove are not fixedly arranged on two lateral surfaces of the filter bag, and the two second outer engaging grooves are close to the water inlet, so that the two second outer engaging grooves and the two first outer latching grooves are provided opposite to each other in pairs in the vertical direction, so that an user can selectively use either the inner engaging groove or the second outer engaging groove.

7. The dual-purpose coffee filter hanging structure according to any one of claims 1-6, characterized in that, the inner ring section extends outwards with a plurality of convex portions, and each convex portion is provided so that a corresponding concave portion is formed inside the outer ring section.

8. The dual-purpose coffee filter hanging structure according to any one of claims 1-6, characterized in that, an outer pulling portion extends outside the inner ring section, and the outer pulling portion causes the outer ring section to be formed with a disconnecting portion, and the disconnecting portion is located between the two first outer engaging grooves.

9. The dual-purpose coffee filter hanging structure according to any one of claims 1-6, characterized in that, the hanging ear device comprises a plurality of cut lines cut into a sheet, such that a plurality of the fixing portion, the connecting section, the inner ring section, each inner engaging groove, the outer ring section and each first outer engaging groove, which are pullable, foldable, or spreadable, are formed on the sheet with each cut line.

10. The dual-purpose coffee filter hanging structure according to any one of claims 1-6, characterized in that, a tearable sealing edge is provided on the water inlet.
